(19) United States
(12) Patent Application Publication
(10) Pub. No.: US 2021/0184231 A1
(43) Pub. Date: Jun. 17, 2021

(54) ELASTOMERIC CELL FRAME FOR FUEL CELL, METHOD OF MANUFACTURING THE SAME, AND UNIT CELL USING THE SAME

(71) Applicants: HYUNDAI MOTOR COMPANY, SEOUL (KR); KIA MOTORS CORPORATION, SEOUL (KR)

(72) Inventors: Byeong-Heon Jeong, Seoul (KR); Jin Hyeok Yoo, Cheonan-si (KR)

(21) Appl. No.: 16/991,319

(22) Filed: Aug. 12, 2020

(30) Foreign Application Priority Data
Dec. 16, 2019 (KR) 10-2019-0167717

(51) Int. Cl. H01M 8/0273; H01M 8/1004; H01M 8/0284; H01M 8/0258; H01M 8/0286

(52) U.S. Cl. CPC H01M 8/0273; H01M 8/1004; H01M 2008/1095; H01M 8/0258; H01M 8/0286; H01M 8/0284

(57) ABSTRACT

An elastomeric cell frame for a fuel cell according to an embodiment of the present disclosure includes, as the cell frame configuring a unit cell of the fuel cell, an insert having a membrane electrode assembly having a pair of electrode layers formed on both surfaces of a polymer electrolyte membrane, and a pair of gas diffusion layers disposed on both surfaces of the membrane electrode assembly bonded; and an elastomeric frame assembly disposed on one surface and the other surface of the rim of the insert, respectively, in the outer region of the insert, and having the polymeric electrolyte membrane and the electrode layers exposed to both surfaces and the side surface of the rim of the insert and having a pair of elastomeric frames bonded at the interface thereof thermally bonded therebetween while being thermally bonded to be formed integrally.

### CROSS REFERENCE TO RELATED APPLICATIONS

The present application claims priority of Korean Patent Application No. 10-2019-0167717 filed on Dec. 16, 2019, the entire contents of which is incorporated herein for all purposes by this reference.

### BACKGROUND

### 1. Field of the Disclosure

The present disclosure relates to an elastomeric cell frame for a fuel cell, a method of manufacturing the same, and a unit cell using the same, and more particularly, to an elastomeric cell frame for a fuel cell, a method of manufacturing the same, and a unit cell using the same, which integrally bond a membrane electrode assembly and gas diffusion layers without a separate adhesive member by using a sheet-shaped elastomeric frame made of a thermoplastic elastomer (TPE).

### 2. Description of the Related Art

A fuel cell is a type of power generator configured to convert chemical energy of a fuel into electrical energy by electrochemically reacting in a stack, and may be not only for industrial use, for home use, and may supply driving power for a vehicle but also may be used for supplying power to miniature electronic products such as portable devices, and in recent years, the usage region thereof is gradually expanding to a highly efficient clean energy source.

A typical unit cell of a fuel cell has a Membrane-Electrode Assembly (MEA) located at the innermost side, and this membrane electrode assembly is composed of a polymer electrolyte membrane capable of transporting hydrogen ions (protons), and a catalyst layer, that is, a cathode and an anode, coated on both surfaces of the polymer electrolyte membrane so that hydrogen and oxygen may react.

In addition, a pair of separators configured to supply reaction gas and discharge water generated by the reaction is disposed on one surface and the other surface of the membrane electrode assembly, that is, the outer portions where the cathode and the anode are located. At this time, a Gas Diffusion Layer (GDL) may be interposed between the membrane electrode assembly and the separator to diffuse or smooth the flow of the reaction gas and the generated water.

Meanwhile, a Membrane-Electrode-Gasket Assembly (MEGA) in which the membrane electrode assembly and the gasket are integrated has been conventionally manufactured and used for the airtightness retention and convenience in a lamination process of a unit cell.

In addition, an integrated frame, wherein an insert comprising a gas diffusion layer and a membrane electrode assembly, and a gasket are integrated has also been proposed.

However, the conventional integrated frame has an insert of a plastic material bonded to the frame by using an adhesive agent. In addition, when manufacturing a unit cell by using the conventional integrated frame, an adhesive member and a sealing member have been separately required for adhering the separator and the integrated frame. Such a process has caused the material cost and the manufacturing cost to rise.

The foregoing explained as the background is intended merely to aid in the understanding of the background of the present disclosure, and is not intended to mean that the present disclosure falls within the purview of the related art that is already known to those skilled in the art.

### SUMMARY

The present disclosure provides an elastomeric cell frame for a fuel cell, a method of manufacturing the same, and a unit cell using the same, which integrally bond a membrane electrode assembly and gas diffusion layers without a separate adhesive member by using a pair of sheet-shaped elastomeric frame made of a thermoplastic elastomer (TPE).

An elastomeric cell frame for a fuel cell according to an embodiment of the present disclosure includes, as the cell frame configuring a unit cell of the fuel cell, an insert having a membrane electrode assembly, in which a pair of electrode layers is formed on both surfaces of a polymer electrolyte membrane, and a pair of gas diffusion layers disposed on both surfaces of the membrane electrode assembly bonded, and an elastomeric frame assembly having a pair of elastomeric frames disposed on one surface and the other surface of the rim of the insert, respectively, and bonded with the polymeric electrolyte membrane and the electrode layers exposed to both surfaces and the side surface of the rim of the insert while being thermally bonded.

The elastomeric frame assembly is composed of a first elastomeric frame formed in a sheet shape and disposed to surround one surface and the side surface of the rim of the insert, having a first insert receiving hole in which the insert is disposed, and having at least one first step surrounding one surface and the side surface of the insert formed on the inner circumferential surface of the first insert receiving hole, and a second elastomeric frame formed in a sheet shape disposed to surround the other surface and the side surface of the rim of the insert, having a second insert receiving hole in which the insert is disposed, and having at least one second step surrounding the other surface and the side surface of the insert formed on the inner circumferential surface of the second insert receiving hole. The insert is configured so that the membrane electrode assembly is composed of the polymer electrolyte membrane, a first electrode layer formed on one surface of the polymer electrolyte membrane, and a second electrode layer formed on the other surface of the polymer electrolyte membrane, and the pair of gas diffusion layers is composed of a first gas diffusion layer bonded to the first electrode layer and a second gas diffusion layer bonded to the second electrode layer, and the insert is configured so that the rim of the polymer electrolyte membrane extends further laterally than at least any one electrode layer of the first electrode layer and the second electrode layer and at least any one surface among one surface and the other surface of the polymer electrolyte membrane, one surface of the first electrode layer, and the other surface of the second electrode layer are bonded while directly facing the elastomeric frame assembly.

The insert has the rim of the polymer electrolyte membrane extending further laterally than the first electrode layer and the second electrode layer, a first bonding part in which the upper surface of the first elastomeric frame and the lower surface of the second elastomeric frame face and are thermally bonded is formed in the outer region of the insert, and between the insert and the elastomeric frame assembly is formed with a second bonding part in which a first step of the first elastomeric frame and one surface and a portion of the side surface of the polymer electrolyte membrane face and are thermally bonded, a third bonding part in which a second step of the second elastomeric frame and the other surface and the remaining portion of the side surface of the polymer electrolyte membrane face and are thermally bonded, a fourth bonding part in which the first step of the first elastomeric frame and one surface and the side surface of the first electrode layer face and are thermally bonded, and a fifth bonding part in which the second step of the second elastomeric frame and the other surface and the side surface of the second electrode layer face and are thermally bonded.

Between the insert and the elastomeric frame assembly is further formed with a sixth bonding part in which the first step of the first elastomeric frame and the side surface of the first gas diffusion layer face and are thermally bonded, and a seventh bonding part in which the second step of the second elastomeric frame and the side surface of the second gas diffusion layer face and are thermally bonded.

The first elastomeric frame is formed with a first step extension part covering one surface of the first gas diffusion layer, and is further formed with an eighth bonding part in which the first step extension part and the other surface of the first gas diffusion layer face and are thermally bonded, and the second elastomeric frame is formed with a second step extension part covering the other surface of the second gas diffusion layer, and is further formed with a ninth bonding part in which the second step extension part and one surface of the second gas diffusion layer face and are thermally bonded.

The insert has the rims of the polymer electrolyte membrane and the second electrode layer extending further laterally than the first electrode layer, a first bonding part in which the upper surface of the first elastomeric frame and the lower surface of the second elastomeric frame face and are thermally bonded is formed in the outer region of the insert, and between the insert and the elastomeric frame assembly is formed with a second bonding part in which the first step of the first elastomeric frame and one surface and a portion of the side surface of the polymer electrolyte membrane face and are thermally bonded, a third bonding part in which the second step of the second elastomeric frame and the remaining portion of the side surface of the polymer electrolyte membrane face and are thermally bonded, a fourth bonding part in which the first step of the first elastomeric frame and one surface and the side surface of the first electrode layer face and are thermally bonded, and a fifth bonding part in which the second step of the second elastomeric frame and the other surface and the side surface of the second electrode layer face and are thermally bonded.

Between the insert and the elastomeric frame assembly is further formed with a sixth bonding part in which the first step of the first elastomeric frame and the side surface of the first gas diffusion layer face and are thermally bonded, and a seventh bonding part in which the second step of the second elastomeric frame and the side surface of the second gas diffusion layer face and are thermally bonded.

The first elastomeric frame is formed with a first step extension part covering one surface of the first gas diffusion layer, and is further formed with an eighth bonding part in which the first step extension part and the other surface of the first gas diffusion layer face and are thermally bonded, and the second elastomeric frame is formed with a second step extension part covering the other surface of the second gas diffusion layer, and is further formed with a ninth bonding part in which the second step extension part and one surface of the second gas diffusion layer face and are thermally bonded.

The insert has the rim of the polymer electrolyte membrane extending further laterally than the first electrode layer and the second electrode layer, the end portion of the rim of the second gas diffusion layer extends to the end portion of the rim of the second electrode layer, the first elastomeric frame is formed with a first step extension part covering one surface of the first gas diffusion layer, the second elastomeric frame is formed with a second step extension part covering the other surface of the second gas diffusion layer, a first bonding part in which the upper surface of the first elastomeric frame and the lower surface of the second elastomeric frame face and are thermally bonded is formed in the outer region of the insert, and between the insert and the elastomeric frame assembly is formed with a second bonding part in which the first step of the first elastomeric frame and one surface and a portion of the side surface of the polymer electrolyte membrane face and are thermally bonded, a third bonding part in which the second step of the second elastomeric frame and the other surface and the remaining portion of the side surface of the polymer electrolyte membrane face and are thermally bonded, a fourth bonding part in which the first step of the first elastomeric frame and one surface and the side surface of the first electrode layer face and are thermally bonded, a fifth bonding part in which the second step of the second elastomeric frame and the side surface of the second electrode layer face and are thermally bonded, a sixth bonding part in which the first step of the first elastomeric frame and the side surface of the first gas diffusion layer face and are thermally bonded, a seventh bonding part in which the second step of the second elastomeric frame and the side surface of the second gas diffusion layer face and are thermally bonded, an eighth bonding part in which the first step extension part and the other surface of the first gas diffusion layer face and are thermally bonded, and a ninth bonding part in which the second step extension part and one surface of the second gas diffusion layer face and are thermally bonded.

The insert has the rims of the polymer electrolyte membrane and the second electrode layer extending further laterally than the first electrode layer, the end portion of the rim of the second gas diffusion layer extends to the end portion of the rim of the second electrode layer, the first elastomeric frame is formed with a first step extension part covering one surface of the first gas diffusion layer, the second elastomeric frame is formed with a second step extension part covering the other surface of the second gas diffusion layer, a first bonding part in which the upper surface of the first elastomeric frame and the lower surface of the second elastomeric frame face and are thermally bonded is formed in the outer region of the insert, and between the insert and the elastomeric frame assembly is formed with a second bonding part in which the first step of the first elastomeric frame and one surface and a portion of the side surface of the polymer electrolyte membrane face and are thermally bonded, a third bonding part in which the second step of the second elastomeric frame and the remaining portion of the side surface of the polymer electrolyte membrane face and are thermally bonded, a fourth bonding part in which the first step of the first elastomeric frame and one surface and the side surface of the first electrode layer face and are thermally bonded, a fifth bonding part in which the second step of the second elastomeric frame and the side surface of the second electrode layer face and are thermally bonded, a sixth bonding part in which the first step of the first elastomeric frame and the side surface of the first gas diffusion layer face and are thermally bonded, a seventh bonding part in which the second step of the second elastomeric frame and the side surface of the second gas diffusion layer face and are thermally bonded, an eighth bonding part in which the first step extension part and the other surface of the first gas diffusion layer face and are thermally bonded, and a ninth bonding part in which the second step extension part and one surface of the second gas diffusion layer face and are thermally bonded.

One side of the first elastomeric frame is formed with a plurality of first manifold inlet through holes into which reaction gas and coolant flow, and the other side thereof is formed with a plurality of first manifold outlet through holes to which the reaction gas and the coolant are discharged, and one side of the second elastomeric frame is formed with a plurality of second manifold inlet through holes communicated with the first manifold inlet through hole, and the other side thereof is formed with a plurality of second manifold outlet through holes communicated with the first manifold outlet through hole.

At least any one surface of both surfaces of the elastomeric frame assembly is formed with at least one protrusion seal surrounding the insert along the outer region of the insert.

The elastomeric frame assembly is composed of a thermoplastic elastomer (TPE).

The thermoplastic elastomer (TPE) may include a resin-based hard-segment and a rubber-based soft-segment.

Meanwhile, a method of manufacturing an elastomeric cell frame for a fuel cell according to an embodiment of the present disclosure includes, as the method of manufacturing the cell frame composing a unit cell of a fuel cell stack, preparing an insert which prepares a membrane electrode assembly by forming a pair of electrode layers on both surfaces of a polymer electrolyte membrane, and prepares an insert by bonding a gas diffusion layer on both surfaces of the prepared membrane electrode assembly, respectively, preparing an elastomeric frame which prepare a pair of elastomeric frames in a sheet shape, disposing the pair of elastomeric frames with the insert interposed therebetween, and bonding which integrally forms the pair of elastomeric frames by applying heat to and compressing them to thermally bond therebetween.

In the preparing of the elastomeric frame, the elastomeric frame may be prepared by molding a thermoplastic elastomer (TPE) into a sheet shape.

In the preparing of the elastomeric frame, the thermoplastic elastomer (TPE) may be formed using a resin-based hard-segment and a rubber-based soft-segment, and in the bonding, heat applied to the pair of elastomeric frames may be higher than the melting temperature of the resin-based hard-segment which forms the elastomeric frame, and lower than a combustion temperature of the rubber-based soft-segment, which forms the elastomeric frame.

In the bonding, the elastomeric frame may be thermally bonded, thereby being assembled to the insert without using a separate adhesive member.

Meanwhile, a unit cell for a fuel cell according to an embodiment of the present disclosure includes an elastomeric cell frame including an insert having a membrane electrode assembly, in which a pair of electrode layers is formed on both surfaces of a polymer electrolyte membrane, and a pair of gas diffusion layers disposed on both surfaces of the polymer electrode assembly bonded, and an elastomeric frame assembly having a pair of elastomeric frames disposed on one surface and the other surface of the rim of the insert, respectively, and bonded with the polymeric electrolyte membrane and the electrode layers exposed to both surfaces and the side surface of the rim of the insert while being thermally bonded; and a pair of separators disposed on both surfaces of the elastomeric cell frame to induce the flow of reaction gas and coolant.

An embodiment of the present disclosure has the following effects.

Firstly, the separate adhesive member may not be necessary for bonding the interface with the separator or the insert, thereby reducing the material cost and saving the manufacturing cost by eliminating the adhesive coating process or the like.

Secondly, it is possible to secure the airtightness of the reaction region without the separate sealing member, and as the sealing member is not necessary, it is possible to reduce the material cost and save the manufacturing cost by eliminating the adhesive coating process and the sealing member molding process or the like.

Thirdly, the moisture generated in the reaction region may be originally prevented from being diffused to the outside of the cell through the electrolyte membrane, thereby preventing the electrical short between the cells, and preventing the fuel cell stack from being corroded by the exposure to the moisture.

Fourthly, it is not necessary to use the electrolyte membrane used in the region other than the reaction region, thereby saving the cost in terms of the material cost.

Fifthly, it is advantageous to reduce the cell pitch as compared to the conventional plastic frame, and it is possible to miniaturize the stack by reducing the volume.

Sixthly, it is possible to expect the effect of reducing the weight as compared to using the adhesive member and the sealing member in the conventional plastic frame.

Seventhly, it is possible to simplify the production line and improve the stack productivity (cell stacking) by reducing the integration process when laminating the fuel cell stack.

Eighthly, it is possible to seat the components of the unit cell in the mold, and then thermally bond and integrate it, thereby improving the bonding precision with the insert to reduce the defect rate and expect the mass production.

### BRIEF DESCRIPTION OF THE FIGURES

The above and other objects, features and other advantages of the present disclosure will be more clearly understood from the following detailed description when taken in conjunction with the accompanying drawings, in which:

FIG. 1 is an exploded perspective diagram showing an elastomeric cell frame for a fuel cell according to an embodiment of the present disclosure.

FIG. 2 is a cross-sectional diagram showing main parts of the elastomeric cell frame for the fuel cell according to an embodiment of the present disclosure.

FIGS. 3, 4, 5, 6, 7, 8, 9, 10, 11, 12, 13, 14, 15, 16, 17, 18, and 19 are cross-sectional diagrams showing main parts of the elastomeric cell frame for the fuel cell according to various embodiments of the present disclosure.

### DETAILED DESCRIPTION

Hereinafter, embodiments of the present disclosure will be described in more detail with reference to the accompanying drawings. However, the present disclosure is not limited to the embodiments disclosed below but will be implemented in various different forms, and the present embodiments are only intended to complete the disclosure of the present disclosure, and provided to completely inform those skilled in the art of the scope of the disclosure. In the drawings, the same reference numerals refer to the same elements.

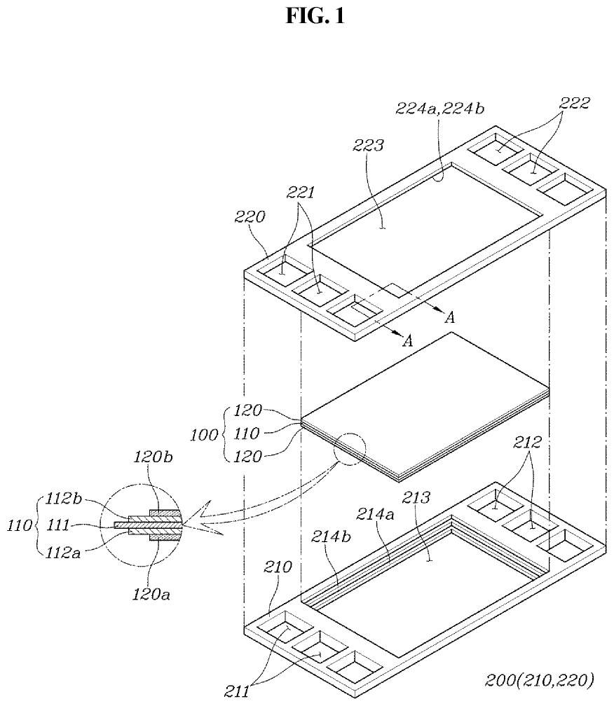

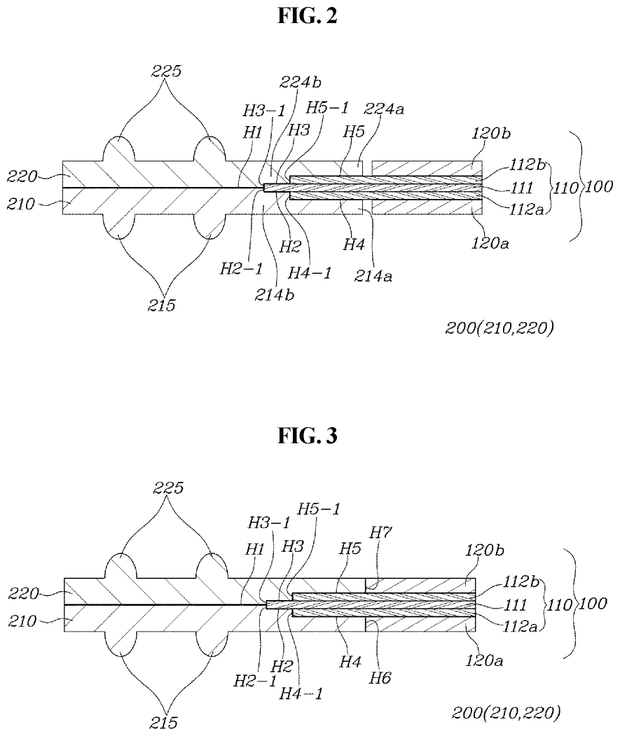

FIG. 1 is an exploded perspective diagram showing an elastomeric cell frame for a fuel cell according to an embodiment of the present disclosure, FIG. 2 is a cross-sectional diagram showing main parts of the elastomeric cell frame for the fuel cell according to an embodiment of the present disclosure, and FIGS. 3 to 19 are cross-sectional diagrams showing main parts of the elastomeric cell frame for the fuel cell according to various embodiments of the present disclosure. At this time, FIGS. 2 to 19 are cross-sectional diagrams taken along line A-A of FIG. 1.

As shown in the drawings, an elastomeric cell frame for a fuel cell according to an embodiment of the present disclosure includes, as an element configuring a unit cell of a fuel cell together with a pair of separators (not shown), an insert 100 in which a membrane electrode assembly 110 and a pair of gas diffusion layers 120a, 120b disposed on both surfaces thereof are bonded; and an elastomeric frame assembly 200 in which a pair of elastomeric frames 210, 220 is formed integrally in the outer region of the insert 100 while being thermally bonded to each other and formed integrally.

The insert 100 is an assembly in which the membrane electrode assembly 110 and the pair of gas diffusion layers 120a, 120b are laminated, and preferably, the gas diffusion layers 120a, 120b are disposed and laminated on one surface and the other surface of the membrane electrode assembly 110, respectively.

Hereinafter, for convenience of explanation, the lower direction of the drawing is defined as one side direction, and the upper direction of the drawing is defined as the other side direction. Accordingly, the lower direction surface in the drawing of both surfaces of each component is referred to as one surface and the upper direction surface in the drawing thereof is referred to as the other surface.

The membrane electrode assembly 110 is implemented as a general membrane electrode assembly composed of a polymer electrolyte membrane capable of transporting hydrogen ions (protons), and electrode layers, that is, a cathode and an anode, having a catalyst coated on both surfaces of the polymer electrolyte membrane so that hydrogen and oxygen may react. Accordingly, the membrane electrode assembly 110 according to the present embodiment is formed with a pair of electrode layers 112a, 112b on both surfaces of the polymer electrolyte membrane 111, that is, a first electrode layer 112a formed on one surface of the polymer electrolyte membrane 111 and a second electrode layer 112b formed on the other surface of the polymer electrolyte membrane 111.

The gas diffusion layers 120a, 120b are means for allowing the reaction gas flowing through a separator (not shown) to diffuse to and pass through the membrane electrode assembly 110, and are formed of a substrate alone or formed of the substrate and a microporous layer (MPL) formed on one surface of the substrate. At this time, the materials of the substrate and the microporous layer are implemented as a material applied to the general gas diffusion layer. Accordingly, the pair of gas diffusion layers according to the present embodiment is composed of a first gas diffusion layer 120a bonded in one side direction of the first electrode layer 112a and a second gas diffusion layer 120b bonded in the other side direction of the second electrode layer 112b.

Meanwhile, the insert 100 is configured so that the polymer electrolyte membrane 111 and the electrode layers 112a, 112b, in which the thermal bonding with the elastomeric frame assembly 200 is relatively easier than the gas diffusion layers 120a, 120b, directly face the elastomeric frame assembly 200 to be easily bonded by the thermal bonding with the elastomeric frame assembly 200. Accordingly, the insert 100 may preferably expose some surfaces or all surfaces among both surfaces and the side surface of the rim of the polymer electrolyte membrane 111, one surface and the side surface of the first electrode layer 112a, and the other surface and the side surface of the second electrode layer 112b.

To this end, as shown in FIG. 2, the insert 100 is configured so that the rim of the polymer electrolyte membrane 111 extends further laterally than the first electrode layer 112a and the second electrode layer 112b so that all of both surfaces and the side surface of the rim of the polymer electrolyte membrane 111, one surface and the side surface of the first electrode layer 112a, and the other surface and the side surface of the second electrode layer 112b are exposed.

The elastomeric frame assembly 200 is a means which is integrally formed in the outer region of the insert 100 for the airtightness retention and the convenience in the lamination process of the insert 100, and has a pair of elastomeric frames 210, 220 thermally bonded to each other and formed integrally. Meanwhile, the pair of elastomeric frames 210, 220 is formed of a thermoplastic elastomer (TPE) in order to be bonded by the thermal bonding without a separate adhesive member while maintaining a predetermined shape.

At this time, the thermoplastic elastomer (TPE) may include a resin-based hard-segment and a rubber-based soft-segment. Accordingly, the resin-based hard-segment contributes to the thermal bonding of the elastomeric frame assembly 200, and the soft-segment contributes to the elasticity and the shape retention.

Accordingly, styrene-based, olefin-based, urethane-based, amide-based, polyester-based, or the like may be applied as the thermoplastic elastomer (TPE), and preferably, a polyolefin-based thermoplastic elastomer (TPE) may be applied. Then, the resin-based hard-segment may be made of a polyolefin resin such as PE or PP, and the rubber-based soft-segment may be made of an olefin-based rubber such as Ethylene Propylene Diene Monomer (EPDM) Rubber.

Meanwhile, the elastomeric frame assembly 200 is formed integrally by thermally bonding the pair of sheet-shaped elastomeric frames 210, 220 disposed on one surface and the other surface of the rim of the insert 100 to each other in the outer region of the insert 100, respectively. In addition, the polymer electrolyte membrane 111 and the electrode layers 112a, 112b exposed to both surfaces and the side surface of the rim of the insert 100 are thermally bonded at the interface thereof to be integrally formed. Here, the ‘outer region’ of the insert 100 means a region including the edge region of the insert 100 and a space nearby the edge region, and the ‘rim’ of the insert 100 means the edge region of the insert 100.

For example, as shown in FIGS. 1 and 2, the elastomeric frame assembly 200 is composed of a first elastomeric frame 210 disposed to surround one surface and the side surface of the rim of the insert 100, and a second elastomeric frame 220 disposed to surround the other surface and the side surface of the rim of the insert 100. At this time, the upper surface of the first elastomeric frame 210 and the lower surface of the second elastomeric frame 220 face each other in the outer region of the insert 100.

In particular, the first elastomeric frame 210 and the second elastomeric frame 220 may have the extended interface with the insert 100 for the airtight adhesion with the insert 100.

For example, the first elastomeric frame 210 is formed with a first insert receiving hole 213 in which the insert 100 is disposed, the inner circumferential surface of the first insert receiving hole 213 is formed with one or more first steps 214a, 214b surrounding one surface and the side surface of the insert 100, the second elastomeric frame 220 is formed with a second insert receiving hole 223 in which the insert 100 is disposed, and the inner circumferential surface of the second insert receiving hole 223 is formed with second steps 224a, 224b surrounding the other surface and the side surface of the insert 100. Accordingly, the first elastomeric frame 210 and the second elastomeric frame 220 have a structure symmetrical to each other with respect to the surface on which the insert 100 is disposed.

Accordingly, a bonding part by the thermal bonding at the interface is formed between the insert 100, the first elastomeric frame 210, and the second elastomeric frame 220, respectively, to firmly bond and integrate them.

That is, as shown in FIG. 2, the insert 100 has the rim of the polymer electrolyte membrane 111 extending further laterally than the first electrode layer 112a and the second electrode layer 112b.

Accordingly, a first bonding part (H1) in which the other surface of the first elastomeric frame 210 and one surface of the second elastomeric frame 220 face each other and are thermally bonded is formed in the outer surface of the insert 100. In addition, between the insert 100 and the elastomeric frame assembly 200 is formed with second bonding parts (H2, H2-1) in which a first step 214b of the first elastomeric frame 210 and one surface and a portion of the side surface of the polymer electrolyte membrane 111 face each other and are thermally bonded. Third bonding parts (H3, H3-1) in which the second step 224b of the second elastomeric frame 220 and the other surface and the remaining portion of the side surface of the polymer electrolyte membrane 111 face each other and are thermally bonded. Fourth bonding parts (H4, H4-1) in which the first steps 214a, 214b of the first elastomeric frame 210 and one surface and the side surface of the first electrode layer 112a face each other and are thermally bonded. Fifth bonding parts (H5, H5-1) in which the second steps 224a, 224b of the second elastomeric frame 220 and the other surface and the side surface of the second electrode layer 112b face each other and are thermally bonded.

At this time, as shown in FIG. 2, the side surface of the first gas diffusion layer 120a and the side surface of the second gas diffusion layer 120b among the side surfaces of the insert 100 may be disposed to be spaced apart from the elastomeric frame assembly 200.

Meanwhile, as in FIG. 3, all of the side surface of the first gas diffusion layer 120a and the side surface of the second gas diffusion layer 120b among the side surfaces of the insert 100 may be disposed to directly face the elastomeric frame assembly 200.

Then, a sixth bonding part (H6) in which the first step 214a of the first elastomeric frame 210 and the side surface of the first gas diffusion layer 120a face each other and are thermally bonded, and a seventh bonding part (H7) in which the second step 224a of the second elastomeric frame 220 and the side surface of the second gas diffusion layer 120b face each other and are thermally bonded are further formed.

However, in this case, since the bonding performance with the elastomeric frame assembly 200 is low due to the characteristics of the materials forming the first gas diffusion layer 120a and the second gas diffusion layer 120b, the bonding force at the corresponding interface may be smaller than the bonding force of the first bonding part (H1) to the fifth bonding parts (H5, H5-1).

Meanwhile, in order to obtain various effects, it is possible to change the lengths of the first electrode layer 112a and the second electrode layer 112b, the first gas diffusion layer 120a, and the second gas diffusion layer 120b and thus, the present disclosure may be performed by variously changing the extended lengths and thicknesses of the first steps 214a, 214b of the first elastomeric frame 210 and the second steps 224a, 224b of the second elastomeric frame 220.

First, as shown in FIG. 4, the lengths of the first gas diffusion layer 120a and the second gas diffusion layer 120b may be formed differently from each other in order to widen the bonding area between the first electrode layer 112a and the second electrode layer 112b, and the elastomeric frame assembly 200. For example, when the second gas diffusion layer 120b extends further laterally than the first gas diffusion layer 120a, the lengths of the first steps 214a, 214b of the first elastomeric frame 210 may be formed longer than the lengths of the second steps 224a, 224b of the second elastomeric frame 220. Then, it is possible to improve the bonding force between the elastomeric frame assembly 200 and the insert 100 by widening the forming area of the fourth bonding part (H4) while preventing the electrical short between the first electrode layer 112a and the second electrode layer 112b.

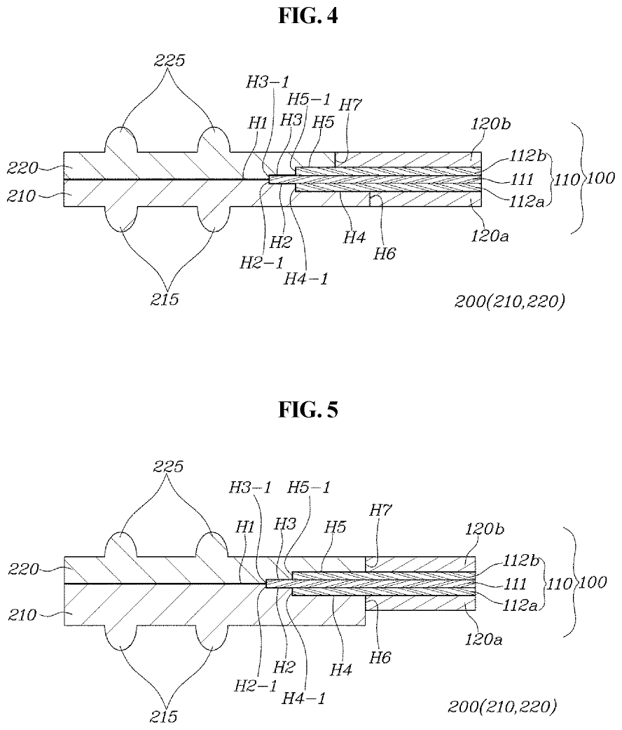

In addition, as shown in FIG. 5, in order to form a flow path in which the reaction gas and the coolant flow in the rim regions of the first elastomeric frame 210 and the second elastomeric frame 220, the thicknesses thereof may be formed thicker than the insert 100. For example, although not shown in FIG. 5, when a flow path is formed at the rim of the first elastomeric frame 210, one side surface of the first elastomeric frame 210 may be formed to further protrude downward than one side surface of the first gas diffusion layer 120a by relatively thickening the thickness of the first elastomeric frame 210. Then, the region where the sixth bonding part (H6) has been formed may be firmly supported while securing the thickness capable of forming the flow path at the rim of the first elastomeric frame 210, thereby improving the bonding force between the elastomeric frame assembly 200 and the insert 100.

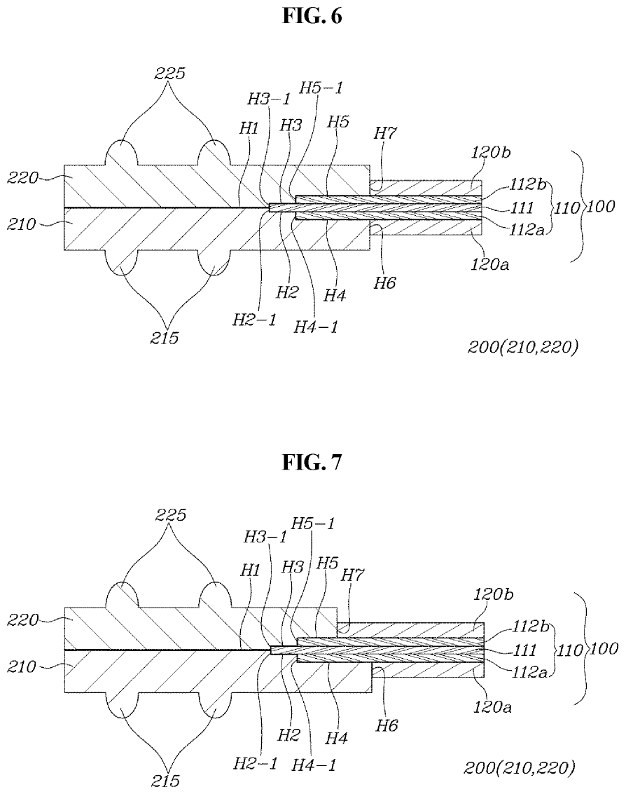

In addition, as shown in FIG. 6, in order to form the flow paths in all of the rim regions of the first elastomeric frame 210 and the second elastomeric frame 220, it is possible to thicken all of the thicknesses of the first elastomeric frame 210 and the second elastomeric frame 220. Accordingly, one side surface of the first elastomeric frame 210 protrudes further downward than one side surface of the first gas diffusion layer 120a, and the other side surface of the second elastomeric frame 220 may be formed to further protrude upward than the other side surface of the second gas diffusion layer 120b.

In addition, as shown in FIG. 7, in order to widen the bonding area between the first electrode layer 112a and the second electrode layer 112b, and the elastomeric frame assembly 200 while forming flow paths in all of the rim regions of the first elastomeric frame 210 and the second elastomeric frame 220, it is possible to form the lengths of the first electrode layer 112a and the second electrode layer 112b differently from each other while thickening all of the thicknesses of the first elastomeric frame 210 and the second elastomeric frame 220.

Meanwhile, in the case of implementing the lengths of the first electrode layer 112a and the second electrode layer 112b differently from each other in order to prevent the electrical short between the first electrode layer 112a and the second electrode layer 112b, the end portion of the second electrode layer 112b may be matched to be aligned with the end portion of the polymer electrolyte membrane 111.

As shown in FIG. 8, the length of the second electrode layer 112b may be formed longer than the length of the first electrode layer 112a to correspond to the polymer electrolyte membrane 111. Then, the insert 100 is implemented in a shape in which the rims of the polymer electrolyte membrane 111 and the second electrode layer 112b extend further laterally than the first electrode layer 112a.

In this case, as in the above-described embodiment, the first bonding part (H1) in which the other surface of the first elastomeric frame 210 and one surface of the second elastomeric frame 220 face each other and are thermally bonded is formed in the outer region of the insert 100.

In addition, between the insert 100 and the elastomeric frame assembly 200 is formed with the second bonding parts (H2, H2-1) in which the first step 214b of the first elastomeric frame 210 and one surface and a portion of the side surface of the polymer electrolyte membrane 111 face each other and are thermally bonded, the third bonding part (H3-1) in which the second step 224b of the second elastomeric frame 220 and the remaining portion of the side surface of the polymer electrolyte membrane 111 face each other and are thermally bonded, the fourth bonding parts (H4, H4-1) in which the first step 214a of the first elastomeric frame 210 and one surface and the side surface of the first electrode layer 112a face each other and are thermally bonded, and fifth bonding parts (H5, H5-1) in which the second step 224a of the second elastomeric frame 220 and the other surface and the side surface of the second electrode layer 112b face each other and are thermally bonded.

At this time, as shown in FIG. 8, the side surface of the first gas diffusion layer 120a and the side surface of the second gas diffusion layer 120b among the side surfaces of the insert 100 may be disposed to be spaced apart from the elastomeric frame assembly 200.

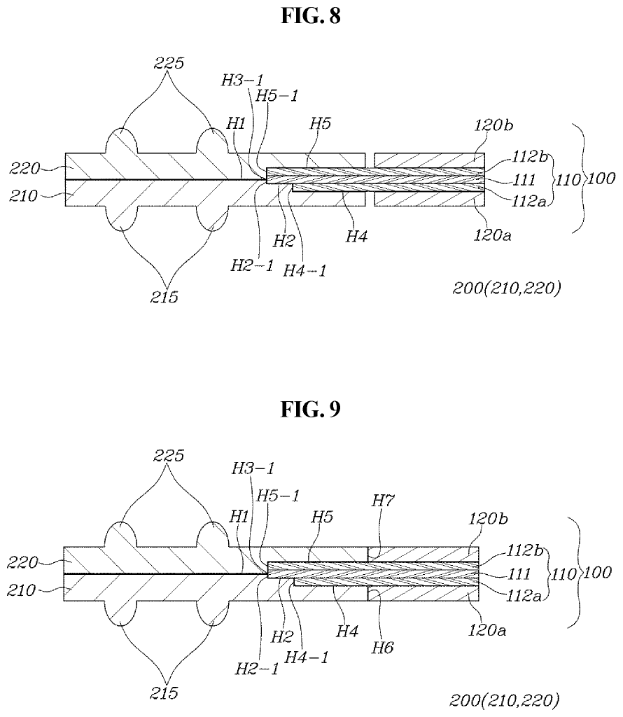

Meanwhile, as in FIG. 9, both the side surface of the first gas diffusion layer 120a and the side surface of the second gas diffusion layer 120b among the side surfaces of the insert 100 may be disposed to directly face the elastomeric frame assembly 200.

Then, the sixth bonding part (H6) in which the first step 214a of the first elastomeric frame 210 and the side surface of the first gas diffusion layer 120a face each other and are thermally bonded, and the seventh bonding part (H7) in which the second step 224a of the second elastomeric frame 220 and the side surface of the second gas diffusion layer 120b face each other and are thermally bonded are further formed.

Meanwhile, in FIGS. 8 and 9 and even in the case of changing the lengths of the first electrode layer 112a and the second electrode layer 112b, the present disclosure may be performed by variously changing the extended lengths and thicknesses of the first steps 214a, 214b of the first elastomeric frame 210 and the second steps 224a, 224b of the second elastomeric frame 220.

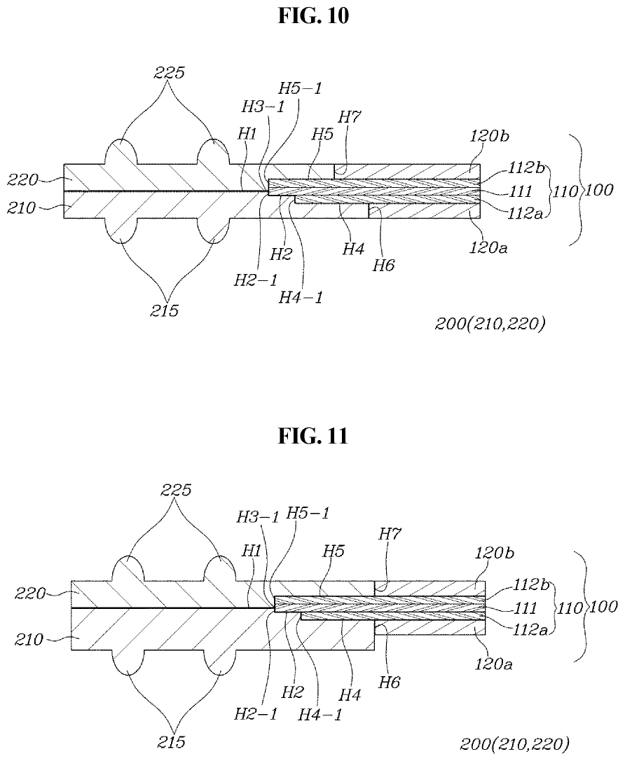

First, as shown in FIG. 10, in the case of matching the end portion of the second electrode layer 112b to be aligned with the end portion of the polymer electrolyte membrane 111 while implementing the lengths of the first electrode layer 112a and the second electrode layer 112b differently from each other in order to prevent the electrical short between the first electrode layer 112a and the second electrode layer 112b, the lengths of the first steps 214a, 214b of the first elastomeric frame 210 may be formed longer than the lengths of the second steps 224a, 224b of the second elastomeric frame 220. Then, it is possible to widen the forming area of the fourth bonding part (H4) while preventing the electrical short between the first electrode layer 112a and the second electrode layer 112b, thereby improving the bonding force between the elastomeric frame assembly 200 and the insert 100.

In addition, as shown in FIG. 11, in order to prevent the electrical short between the first electrode layer 112a and the second electrode layer 112b, it is possible to form a flow path at the rim of the first elastomeric frame 210 while implementing the lengths of the first electrode layer 112a and the second electrode layer 112b differently from each other. To this end, one side surface of the first elastomeric frame 210 may be formed to protrude further downward than one side surface of the first gas diffusion layer 120a by relatively thickening the thickness of the first elastomeric frame 210 in a state where the end portion of the second electrode layer 112b has been matched to be aligned with the end portion of the polymer electrolyte membrane 111. Then, it is possible to firmly support the region in which the sixth bonding part (H6) has been formed while securing the thickness capable of forming the flow path at the rim of the first elastomeric frame 210, thereby improving the bonding force between the elastomeric frame assembly 200 and the insert 100.

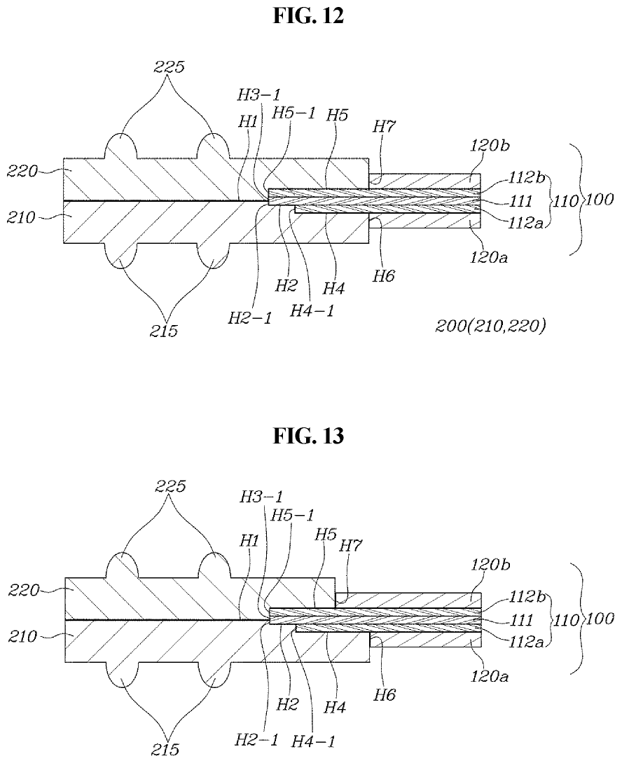

In addition, as shown in FIG. 12, it is possible to form the flow path in all of the rim regions of the first elastomeric frame 210 and the second elastomeric frame 220 while implementing the lengths of the first electrode layer 112a and the second electrode layer 112b differently from each other in order to prevent the electrical short between the first electrode layer 112a and the second electrode layer 112b. To this end, it is possible to thicken both the thicknesses of the first elastomeric frame 210 and the second elastomeric frame 220 in the state where the end portion of the second electrode layer 112b has been matched to be aligned with the end portion of the polymer electrolyte membrane 111. Accordingly, one side surface of the first elastomeric frame 210 protrudes further downward than one side surface of the first gas diffusion layer 120a, and the other side surface of the second elastomeric frame 220 may be formed to protrude further upward than the other side surface of the second gas diffusion layer 120b.

In addition, as shown in FIG. 13, it is possible to form the flow path in all of the rim regions of the first elastomeric frame 210 and the second elastomeric frame 220 while implementing the lengths of the first electrode layer 112a and the second electrode layer 112b differently from each other in order to prevent the electrical short between the first electrode layer 112a and the second electrode layer 112b. To this end, it is possible to thicken both the thicknesses of the first elastomeric frame 210 and the second elastomeric frame 220 in the state where the end portion of the second electrode layer 112b has been matched to be aligned with the end portion of the polymer electrolyte membrane 111. In addition, in this case, it is possible to implement the extending lengths of the first steps 214a, 214b of the first elastomeric frame 210 and the extending lengths of the second steps 224a, 224b of the second elastomeric frame 220 differently from each other.

Meanwhile, the first elastomeric frame 210 and the second elastomeric frame 220 may be provided with means for further securing the bonding force between the first gas diffusion layer 120a and the second gas diffusion layer 120b.

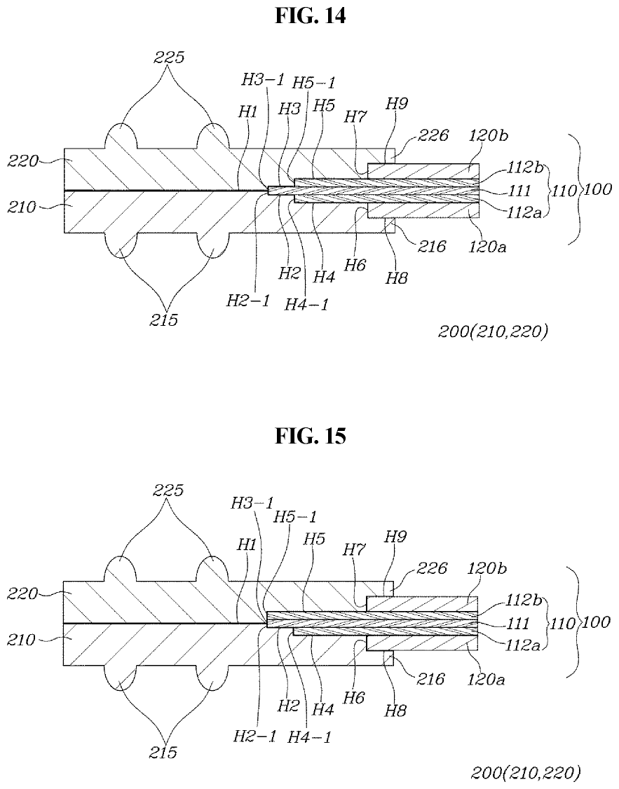

As shown in FIG. 14, the first elastomeric frame 210 may be formed with a first step extension part 216 covering one surface of the first gas diffusion layer 120a, and the second elastomeric frame 220 may be formed with a second step extension part 226 covering the other surface of the second gas diffusion layer 120b.

Then, as in the above-described embodiments, while the first bonding part (H1) to the seventh bonding part (H7) are formed, an eighth bonding part (H8) in which the first step extension part 216 and the other surface of the first gas diffusion layer 120a face each other and are thermally bonded, and a ninth bonding part (H9) in which the second step extension part 226 and one surface of the second gas diffusion layer 120b face each other and are thermally bonded are further formed.

Accordingly, since the bonding performance with the elastomeric frame assembly 200 is low due to the characteristics of the materials forming the first gas diffusion layer 120a and the second gas diffusion layer 120b, it is possible to further form the eighth bonding part (H8) and the ninth bonding part (H9), thereby improving the bonding force between the insert 100 and the elastomeric frame assembly 200.

In addition, as shown in FIG. 15, even in the case of matching the end portion of the second electrode layer 112b to be aligned with the end portion of the polymer electrolyte membrane 111 while implementing the lengths of the first electrode layer 112a and the second electrode layer 112b differently from each other in order to prevent the electrical short between the first electrode layer 112a and the second electrode layer 112b, the first step extension part 216 and the second step extension part 226 may be formed.

Even in this case, as in the above-described embodiment, it is possible to further form the eighth bonding part (H8) and the ninth bonding part (H9), thereby improving the bonding force between the insert 100 and the elastomeric frame assembly 200.

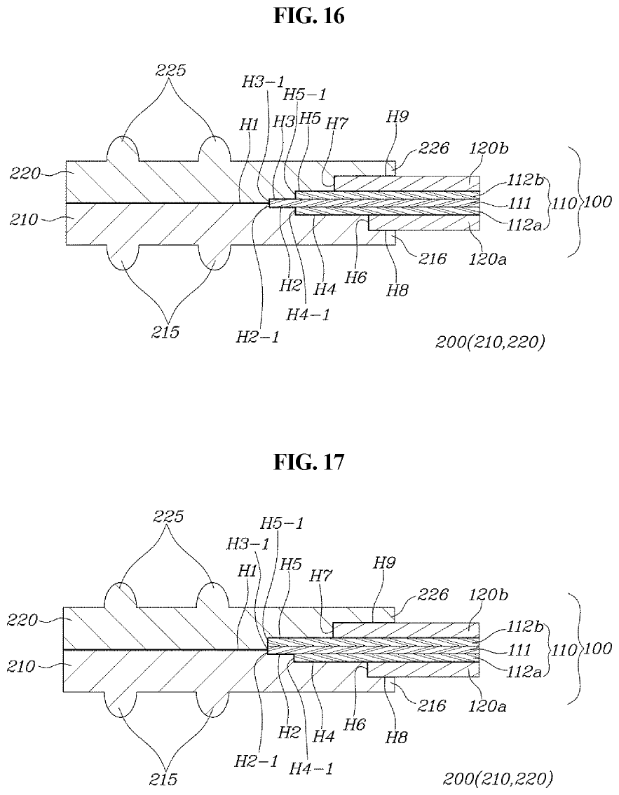

In addition, FIG. 16 is a modified embodiment of the embodiment shown in FIG. 14, and in FIG. 16, the first elastomeric frame 210 is formed with the first step extension part 216 which covers one surface of the first gas diffusion layer 120a, and the second elastomeric frame 220 is formed with the second step extension part 226 which covers the other surface of the second gas diffusion layer 120b, as in the embodiment shown in FIG. 14. Further, the lengths of the first gas diffusion layer 120a and the second gas diffusion layer 120b may be formed differently from each other.

Further, FIG. 17 is a modified embodiment of the embodiment shown in FIG. 15, and in FIG. 17, the first elastomeric frame 210 is formed with the first step extension part 216 which covers one surface of the first gas diffusion layer 120a, the second elastomeric frame 220 is formed with the second step extension part 226 which covers the other surface of the second gas diffusion layer 120b, and the lengths of the first electrode layer 112a and the second electrode layer 112b are formed differently from each other, as in the embodiment shown in FIG. 15. Further, the lengths of the first gas diffusion layer 120a and the second gas diffusion layer 120b may be formed differently from each other.

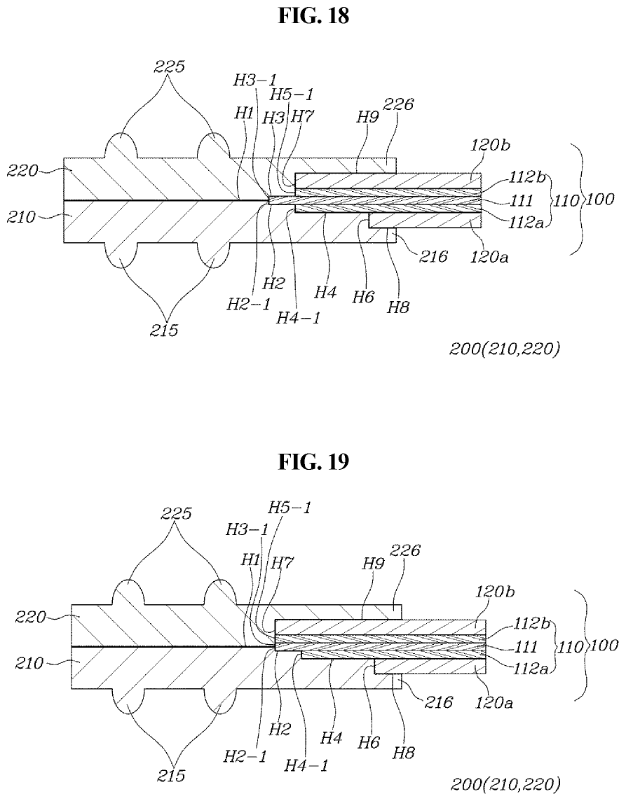

Meanwhile, FIG. 18 is a modified embodiment of the embodiment illustrated in FIG. 16, and in FIG. 18, the first elastomeric frame 210 may be formed with the first step extension part 216 which covers one surface of the first gas diffusion layer 120a, the second elastomeric frame 220 may be formed with the second step extension part 226 which covers the other surface of the second gas diffusion layer 120b, and the lengths of the first gas diffusion layer 120a and the second gas diffusion layer 120b may be formed differently from each other, as in the embodiment shown in FIG. 16. At this time, the length of the second gas diffusion layer 120b may extend to correspond to the second electrode layer 112b.

Further, FIG. 19 is a modified embodiment of the embodiment shown in FIG. 17, and in FIG. 19, the first elastomeric frame 210 is formed with the first step extension part 216 which covers one surface of the first gas diffusion layer 120a, the second elastomeric frame 220 is formed with the second step extension part 226 which covers the other surface of the second gas diffusion layer 120b, and the lengths of the first electrode layer 112a and the second electrode layer 112b are formed differently from each other, as in the embodiment shown in FIG. 17. Further, the lengths of the first gas diffusion layer 120a and the second gas diffusion layer 120b may be formed differently from each other. At this time, the length of the second gas diffusion layer 120b may extend to correspond to the second electrode layer 112b.

Meanwhile, the elastomeric frame assembly 200 is formed with a manifold inlet through hole and a manifold outlet through hole for forming manifolds for the reaction gas and the coolant.

For example, a plurality of first manifold inlet through holes 211 into which the reaction gas and the coolant flow are formed at one side of the first elastomeric frame 210, and a plurality of first manifold outlet through holes 212 to which the reaction gas and the coolant are discharged are formed at the other side thereof. In addition, a plurality of second manifold inlet through holes 221 are formed at one side of the second elastomeric frame 220, and a plurality of second manifold outlet through holes 222 are formed at the other side thereof.

Accordingly, the plurality of first manifold inlet through holes 211 formed in the first elastomeric frame 210 and the plurality of second manifold inlet through holes 221 formed in the second elastomeric frame 220 are disposed at positions corresponding to each other and communicate with each other. In addition, the plurality of first manifold outlet through holes 212 formed in the first elastomeric frame 210 and the plurality of second manifold outlet through holes 222 formed in the second elastomeric frame 220 are disposed at positions corresponding to each other and communicate with each other.

Meanwhile, the elastomeric frame assembly 200 may be formed with a means for the airtightness and adhesion with the separator.

For example, at least one first protrusion seal 215 surrounding the insert along the outer region of the insert 100 may be formed on the lower surface of the first elastomeric frame 210. In addition, at least one second protrusion seal 225 surrounding the insert 100 along the outer region of the insert 100 may be formed on the upper surface of the second elastomeric frame 220.

Meanwhile, a method of manufacturing the elastomeric cell frame for the fuel cell configured as described above will be described.

The method of manufacturing the elastomeric cell frame for the fuel cell according to an embodiment of the present disclosure includes preparing the insert which prepares the membrane electrode assembly 110 by forming the pair of electrode layers 112a, 112b on both surfaces of the polymer electrolyte membrane 111, and prepares the insert 100 by bonding the gas diffusion layers 120a, 120b on both surfaces of the prepared membrane electrode assembly 110, respectively, preparing the elastomeric frame which prepares the pair of elastomeric frames 210, 220 in a sheet shape, disposing the pair of elastomeric frames 210, 220 with the insert 100 interposed therebetween, and bonding which integrally forms the pair of elastomeric frames 210, 220 by applying heat to and compressing them while thermally bonding each other.

The preparing of the insert is to prepare the insert 100 by bonding the membrane electrode assembly 110, the first gas diffusion layer 120a, and the second gas diffusion layer 120b.

At this time, the membrane electrode assembly 110 is prepared as a general membrane electrode assembly composed of the polymer electrolyte membrane 111, and the first electrode layer 112a and the second electrode layer 112b formed on both surfaces of the polymer electrolyte membrane 111. However, the insert 100 is configured so that the polymer electrolyte membrane 111 and the electrode layers 112a, 112b, which are relatively easier to be thermally bonded with the elastomeric frame assembly 200 than the gas diffusion layers 120a, 120b, directly face the elastomeric frame assembly 200 in order to be easily bonded by the thermal bonding with the elastomeric frame assembly 200. To this end, as in various embodiments described above, the polymer electrolyte membrane 111, the first electrode layer 112a, and the second electrode layer 112b may be prepared by variously changing the length of the side end portions thereof

In addition, the first gas diffusion layer 120a and the second gas diffusion layer 120b is also prepared as a general gas diffusion layer which is formed of a substrate alone, or is formed of a substrate and a microporous layer (MPL) formed on one surface of the substrate. Even at this time, likewise, as in the various embodiments described above, the first gas diffusion layer 120a and the second gas layer 120b may be prepared by variously changing the lengths of the side end portions thereof.

In addition, the insert 100 is prepared by laminating the first gas diffusion layer 120a and the second gas diffusion layer 120b on both surfaces of the membrane electrode assembly 110.

The preparing of the elastomeric frame is to prepare the sheet-shaped elastomeric frames 210, 220 disposed on the upper surface and the lower surface of the insert 100.

At this time, the elastomeric frames 210, 220 are prepared by molding a thermoplastic elastomer (TPE) in a sheet shape. At this time, the elastomeric frame is preferably prepared by molding the thermoplastic elastomer into the sheet shape by injection molding.

The disposing disposes the pair of elastomeric frames 210, 220 so that the rim of the insert 100 overlaps with the pair of elastomeric frames 210, 220. Preferably, the lower surface of the rim of the insert 100 is seated on the first steps 214a, 214b of the first elastomeric frame 210 so that the side surface of the rim of the insert 100 faces the inner circumferential surface of the first insert receiving hole 213 of the first elastomeric frame 210. In addition, the upper surface of the rim of the insert 100 is seated on the second steps 224a, 224b of the second elastomeric frame 220 so that the side surface of the rim of the insert 100 faces the inner circumferential surface of the second insert receiving hole 223 of the second elastomeric frame 220.

The bonding is to bond the pair of elastomeric frames 210, 220 and the insert 100 to each other by the thermal bonding of the elastomeric frames 210, 220.

In the bonding, the method of thermally bonding the overlapping portions between the pair of elastomeric frames 210, 220 and the insert 100 may use various methods capable of simultaneously providing heat and pressure. For example, the thermal bonding method may be performed in any one bonding method among Hot-press bonding, Ultrasonic bonding, High frequency bonding, Vibration bonding, Infrared bonding, Radiant-heat bonding, Calender bonding, and Laser bonding. It is preferable to thermally bond the overlapping portion between the elastomeric frame and the insert in the hot-press bonding method, which easily provides heat and pressure.

To this end, the pair of elastomeric frames 210, 220 and the insert 100 are seated in a hot press mold. At this time, the insert 100 is disposed to be interposed between the pair of elastomeric frames 210, 220.

In addition, the hot press mold is operated to apply heat to and compress some or all of the regions corresponding to the outer region of the insert 100, such that the pair of elastomeric frames 210, 220 are bonded and at the same time, the pair of elastomeric frames 210, 220 and the insert 100 are bonded to each other.

Accordingly, the pair of elastomeric frames 210, 220 and the insert 100 are bonded while the elastomeric frames 210, 220 are thermally bonded at the interfaces thereof even without a separate adhesive member.

At this time, the heat applied to the elastomeric frame assembly 200 for firmly bonding the elastomeric frame assembly 200, to which the pair of elastomeric frames 210, 220 has been bonded, and the insert 100 has preferably a temperature higher than the melting temperature of the elastomeric frame assembly 200. Accurately, when the thermoplastic elastomer (TPE) applied to the elastomeric frame may include a resin-based hard-segment and a rubber-based soft-segment, the heat applied to the elastomeric frame assembly 200 is preferably kept higher than the melting temperature of the resin-based hard-segment and lower than the combustion temperature of the rubber-based soft-segment. This is because there is a problem in that if the temperature of the heat applied to the elastomeric frame assembly 200 is lower than the melting temperature of the resin-based hard-segment, no elastomeric frame assembly 200 is melted and thermally bonded, and if the temperature of the heat applied to the elastomeric frame assembly 200 is higher than the combustion temperature of the rubber-based soft-segment, the rubber-based soft-segment is combusted.

Meanwhile, the elastomeric cell frame for the fuel cell configured as described above configures a unit cell for a fuel cell together with the separator.

That is, the unit cell for the fuel cell includes an elastomeric cell frame including an insert having a membrane electrode assembly 110, in which the pair of electrode layers 112a, 112b is formed on both surfaces of the polymer electrolyte membrane 111, and the pair of gas diffusion layers 120a, 120b disposed on both surfaces of the polymer electrode assembly 112a, 112b bonded; and an elastomeric frame assembly disposed on one surface and the other surface of the rim of the insert, respectively, in the outer region of the insert, and having the polymer electrolyte membrane and the electrode layers exposed to both surfaces and the side surface of the rim of the insert and the pair of elastomeric frames bonded at the interface thereof formed integrally while being thermally bonded to each other; and a pair of separators (not shown) disposed on both surfaces of the elastomeric cell frame to induce the flow of reaction gas and coolant.

In addition, a metal porous body (not shown) or the like which further facilitates the diffusion of the reaction gas may be further included between the pair of gas diffusion layers 120a, 120b and the separator.

While the disclosure has been described with reference to the accompanying drawings and the preferred embodiments described above, the disclosure is not limited thereto, but is defined by the claims to be described later. Accordingly, those skilled in the art may variously change and modify the present disclosure without departing from the technical spirit of the appended claims to be described later.

1. An elastomeric cell frame for a fuel cell comprising:
an insert having a membrane electrode assembly, in which a pair of electrode layers is formed on both surfaces of a polymer electrolyte membrane, and having a pair of gas diffusion layers disposed on both surfaces of the membrane electrode assembly bonded; and
an elastomeric frame assembly having a pair of elastomeric frames disposed on one surface and the other surface of the rim of the insert, respectively, and bonded with the polymeric electrolyte membrane and the electrode layers exposed to both surfaces and the side surface of the rim of the insert while being thermally bonded.

2. The elastomeric cell frame for the fuel cell according to claim 1,
wherein the elastomeric frame assembly comprises:
a first elastomeric frame formed in a sheet shape and disposed to surround one surface and the side surface of the rim of the insert, having a first insert receiving hole in which the insert is disposed formed therein, and having at least one first step surrounding one surface and the side surface of the insert formed on the inner circumferential surface of the first insert receiving hole; and
a second elastomeric frame formed in a sheet shape and disposed to surround the other surface and the side surface of the rim of the insert, having a second insert receiving hole in which the insert is disposed formed therein, and having at least one second step surrounding the other surface and the side surface of the insert formed on the inner circumferential surface of the second insert receiving hole;
wherein the insert is configured so that:
the membrane electrode assembly comprises the polymer electrolyte membrane, a first electrode layer formed on one surface of the polymer electrolyte membrane, and a second electrode layer formed on the other surface of the polymer electrolyte membrane; and
the pair of gas diffusion layers comprises a first gas diffusion layer bonded to the first electrode layer and a second gas diffusion layer bonded to the second electrode layer; and
wherein the insert is configured so that the rim of the polymer electrolyte membrane extends further laterally than at least any one electrode layer of the first electrode layer and the second electrode layer and at least any one surface of one surface and the other surface of the polymer electrolyte membrane, one surface of the first electrode layer, and the other surface of the second electrode layer is bonded while directly facing the elastomeric frame assembly.

3. The elastomeric cell frame for the fuel cell according to claim 2,
wherein the insert has the rim of the polymer electrolyte membrane extending further laterally than the first electrode layer and the second electrode layer;
wherein a first bonding part in which the upper surface of the first elastomeric frame and the lower surface of the second elastomeric frame face and are thermally bonded is formed in the outer region of the insert; and
wherein between the insert and the elastomeric frame assembly is formed with:
a second bonding part in which a first step of the first elastomeric frame and one surface and a portion of the side surface of the polymer electrolyte membrane face and are thermally bonded;
a third bonding part in which a second step of the second elastomeric frame and the other surface and the remaining portion of the side surface of the polymer electrolyte membrane face and are thermally bonded;
a fourth bonding part in which the first step of the first elastomeric frame and one surface and the side surface of the first electrode layer face and are thermally bonded; and
a fifth bonding part in which the second step of the second elastomeric frame and the other surface and the side surface of the second electrode layer face and are thermally bonded.

4. The elastomeric cell frame for the fuel cell according to claim 3,
wherein between the insert and the elastomeric frame assembly is further formed with:
a sixth bonding part in which the first step of the first elastomeric frame and the side surface of the first gas diffusion layer face and are thermally bonded; and
a seventh bonding part in which the second step of the second elastomeric frame and the side surface of the second gas diffusion layer face and are thermally bonded.

5. The elastomeric cell frame for the fuel cell according to claim 4,
wherein the first elastomeric frame is formed with a first step extension part covering one surface of the first gas diffusion layer; and
is further formed with an eighth bonding part in which the first step extension part and the other surface of the first gas diffusion layer face and are thermally bonded; and
wherein the second elastomeric frame is formed with a second step extension part covering the other surface of the second gas diffusion layer; and
is further formed with a ninth bonding part in which the second step extension part and one surface of the second gas diffusion layer face and are thermally bonded.

6. The elastomeric cell frame for the fuel cell according to claim 2,
wherein the insert has the rims of the polymer electrolyte membrane and the second electrode layer extending further laterally than the first electrode layer;
wherein a first bonding part in which the upper surface of the first elastomeric frame and the lower surface of the second elastomeric frame face and are thermally bonded is formed in the outer region of the insert; and
wherein between the insert and the elastomeric frame assembly is formed with:
a second bonding part in which a first step of the first elastomeric frame and one surface and a portion of the side surface of the polymer electrolyte membrane face and are thermally bonded;
a third bonding part in which a second step of the second elastomeric frame and the remaining portion of the side surface of the polymer electrolyte membrane face and are thermally bonded;
a fourth bonding part in which the first step of the first elastomeric frame and one surface and the side surface of the first electrode layer face and are thermally bonded; and
a fifth bonding part in which the second step of the second elastomeric frame and the other surface and the side surface of the second electrode layer face and are thermally bonded.

7. The elastomeric cell frame for the fuel cell according to claim 6,
wherein between the insert and the elastomeric frame assembly is further formed with:
a sixth bonding part in which the first step of the first elastomeric frame and the side surface of the first gas diffusion layer face and are thermally bonded; and
a seventh bonding part in which the second step of the second elastomeric frame and the side surface of the second gas diffusion layer face and are thermally bonded.

8. The elastomeric cell frame for the fuel cell according to claim 7,
wherein the first elastomeric frame is formed with a first step extension part covering one surface of the first gas diffusion layer; and
is further formed with an eighth bonding part in which the first step extension part and the other surface of the first gas diffusion layer face and are thermally bonded; and
wherein the second elastomeric frame is formed with a second step extension part covering the other surface of the second gas diffusion layer; and
is further formed with a ninth bonding part in which the second step extension part and one surface of the second gas diffusion layer face and are thermally bonded.

9. The elastomeric cell frame for the fuel cell according to claim 2,
wherein the insert has the rim of the polymer electrolyte membrane extending further laterally than the first electrode layer and the second electrode layer;
wherein the end portion of the rim of the second gas diffusion layer extends to the end portion of the rim of the second electrode layer;
wherein the first elastomeric frame is formed with a first step extension part covering one surface of the first gas diffusion layer;
wherein the second elastomeric frame is formed with a second step extension part covering the other surface of the second gas diffusion layer;
wherein a first bonding part in which the upper surface of the first elastomeric frame and the lower surface of the second elastomeric frame face and are thermally bonded is formed in the outer region of the insert; and
wherein between the insert and the elastomeric frame assembly is formed with:
a second bonding part in which a first step of the first elastomeric frame and one surface and a portion of the side surface of the polymer electrolyte membrane face and are thermally bonded;
a third bonding part in which a second step of the second elastomeric frame and the other surface and the remaining portion of the side surface of the polymer electrolyte membrane face and are thermally bonded;
a fourth bonding part in which the first step of the first elastomeric frame and one surface and the side surface of the first electrode layer face and are thermally bonded;
a fifth bonding part in which the second step of the second elastomeric frame and the side surface of the second electrode layer face and are thermally bonded;
a sixth bonding part in which the first step of the first elastomeric frame and the side surface of the first gas diffusion layer face and are thermally bonded;
a seventh bonding part in which the second step of the second elastomeric frame and the side surface of the second gas diffusion layer face and are thermally bonded;
an eighth bonding part in which the first step extension part and the other surface of the first gas diffusion layer face and are thermally bonded; and
a ninth bonding part in which the second step extension part and one surface of the second gas diffusion layer face and are thermally bonded.

10. The elastomeric cell frame for the fuel cell according to claim 2,
wherein the insert has the rims of the polymer electrolyte membrane and the second electrode layer extending further laterally than the first electrode layer;
wherein the end portion of the rim of the second gas diffusion layer extends to the end portion of the rim of the second electrode layer;
wherein the first elastomeric frame is formed with a first step extension part covering one surface of the first gas diffusion layer;
wherein the second elastomeric frame is formed with a second step extension part covering the other surface of the second gas diffusion layer;
wherein a first bonding part in which the upper surface of the first elastomeric frame and the lower surface of the second elastomeric frame face and are thermally bonded is formed in the outer region of the insert; and
wherein between the insert and the elastomeric frame assembly is formed with:
a second bonding part in which a first step of the first elastomeric frame and one surface and a portion of the side surface of the polymer electrolyte membrane face and are thermally bonded;
a third bonding part in which a second step of the second elastomeric frame and the remaining portion of the side surface of the polymer electrolyte membrane face and are thermally bonded;
a fourth bonding part in which the first step of the first elastomeric frame and one surface and the side surface of the first electrode layer face and are thermally bonded;
a fifth bonding part in which the second step of the second elastomeric frame and the side surface of the second electrode layer face and are thermally bonded;
a sixth bonding part in which the first step of the first elastomeric frame and the side surface of the first gas diffusion layer face and are thermally bonded;
a seventh bonding part in which the second step of the second elastomeric frame and the side surface of the second gas diffusion layer face and are thermally bonded;
an eighth bonding part in which the first step extension part and the other surface of the first gas diffusion layer face and are thermally bonded; and
a ninth bonding part in which the second step extension part and one surface of the second gas diffusion layer face and are thermally bonded.

11. The elastomeric cell frame for the fuel cell according to claim 2,
wherein one side of the first elastomeric frame is formed with a plurality of first manifold inlet through holes into which reaction gas and coolant flow, and the other side thereof is formed with a plurality of first manifold outlet through holes to which the reaction gas and the coolant are discharged; and
wherein one side of the second elastomeric frame is formed with a plurality of second manifold inlet through holes communicated with the first manifold inlet through hole, and the other side thereof is formed with a plurality of second manifold outlet through holes communicated with the first manifold outlet through hole.

12. The elastomeric cell frame for the fuel cell according to claim 1,
wherein at least any one surface of both surfaces of the elastomeric frame assembly is formed with at least one protrusion seal surrounding the insert along the outer region of the insert.

13. The elastomeric cell frame for the fuel cell according to claim 1,
wherein the elastomeric frame assembly is composed of a thermoplastic elastomer (TPE).

14. The elastomeric cell frame for the fuel cell according to claim 13,
wherein the thermoplastic elastomer (TPE) comprises a resin-based hard-segment and a rubber-based soft-segment.

15. A method of manufacturing an elastomeric cell frame for a fuel cell, the method comprising:
preparing an insert which prepares a membrane electrode assembly by forming a pair of electrode layers on both surfaces of a polymer electrolyte membrane, and prepares an insert by bonding a gas diffusion layer on both surfaces of the prepared membrane electrode assembly, respectively;
preparing a pair of elastomeric frames in a sheet shape;
disposing the pair of elastomeric frames with the insert interposed therebetween; and
bonding which integrally forms the pair of elastomeric frames by applying heat to and compressing the pair of elastomeric frames to thermally bond therebetween.

16. The method according to claim 15,
wherein preparing the pair of elastomeric frames comprises molding a thermoplastic elastomer (TPE) into a sheet shape.

17. The method according to claim 16,
wherein the thermoplastic elastomer (TPE) is composed of a resin-based hard-segment and a rubber-based soft-segment; and
wherein during the bonding, the heat applied to the pair of the elastomeric frames is higher than the melting temperature of the resin-based hard-segment, which forms the elastomeric frame, and lower than the combustion temperature of the rubber-based soft-segment, which forms the elastomeric frame.

18. The method according to claim 15,
wherein during the bonding, the pair of elastomeric frames are bonded to the insert while being thermally bonded without a separate adhesive member.

19. A unit cell for a fuel cell, comprising:
an elastomeric cell frame comprising an insert having a membrane electrode assembly, in which a pair of electrode layers is formed on both surfaces of a polymer electrolyte membrane, and a pair of gas diffusion layers disposed on both surfaces of the polymer electrode assembly bonded; and an elastomeric frame assembly disposed on one surface and the other surface of the insert, respectively, in the outer region of the insert, and having a polymer electrolyte membrane and electrode layers exposed to both surfaces and the side surface of the rim of the insert and having a pair of elastomeric frames bonded at the interface thereof thermally bonded therebetween while being thermally bonded to be formed integrally; and
a pair of separators disposed on both surfaces of the elastomeric cell frame to induce the flow of reaction gas and coolant.
